(19) United States
(12) Patent Application Publication
(10) Pub. No.: US 2007/0021553 A1
(43) Pub. Date: Jan. 25, 2007

(54) Coating material which is thermally curable and curable by means of actinic radiation and method for coating microporous surfaces

(75) Inventors: Yvonne Lichte, Munster (DE); Heinrich Wonnemann, Telgte (DE)

Correspondence Address: BASF CORPORATION, 1609 BIDDLE AVENUE, WYANDOTTE, MI, 48192, US

(73) Assignee: BASF Coatings Aktiengesellschaft,, Munster (DE)

(21) Appl. No.: 10/531,633

(22) PCT Filed: Sep. 29, 2003
(86) PCT No.: PCT/EP03/10791

§ 371 Date: Apr. 6, 2005

(30) Foreign Application Priority Data
Oct. 17, 2002 (DE) 102 48 324.8

(51) Int. Cl. C08G 18/08

(52) U.S. Cl. 524/591; 427/595

(57) ABSTRACT

A coating material curable thermally and with actinic radiation and comprising (a1) at least one constituent containing (a11) on average per molecule at least two functional groups which contain at least one bond which can be activated with actinic radiation and which serves for crosslinking with actinic radiation and, if desired, (a12) at least one isocyanate-reactive group, (a2) at least one thermally curable constituent having at least two isocyanate-reactive groups, and (a3) at least one aromatic polyisocyanate which is free from functional groups (a11), or a mixture of at least one aromatic polyisocyanate which is free from functional groups (a11) and of at least one (cyclo)aliphatic polyisocyanate which is free from functional groups (a11); and its use for coating microporous surfaces, especially of SMCs and BMCs.

### FIELD OF THE INVENTION

The present invention relates to a novel coating material curable thermally and with actinic radiation. The present invention further relates to a novel process for coating, especially sealing, microporous surfaces of all kinds, especially the microporous surfaces of shaped components of wood, glass, leather, plastics, metals, mineral substances, especially fired and unfired clay, ceramic, natural and artificial stone or cement; fiber materials, especially glass fibers, ceramic fibers, carbon fibers, textile fibers, polymer fibers or metal fibers, and composites of these fibers; or fiber-reinforced materials, especially plastics reinforced with the aforementioned fibers, and in particular the porous surfaces of SMC (sheet molded compounds) and BMC (bulk molded compounds).

### PRIOR ART

In the coating of porous surfaces, especially microporous surfaces having pores with a size of from 10 to 1500 nm, with heat-curable coating materials there is frequently outgassing of volatile constituents from the shaped components at the temperatures employed to bake the applied coating materials. This leads to unwanted surface defects, such as microbubbles (blisters).

These problems are manifested with particular unattractiveness in the case of SMCs and BMCs.

SMCs and BMCs have been used for a long time to produce sanitary articles, domestic appliances and structural components of complex shape, especially for automotive construction, such as protective panels, fenders, doors or lamp reflectors. Because of their structure and their physical composition based on glass fibers, the SMCs and BMCs are of high temperature resistance and withstand temperatures of 190-200° C. with little deformation. Furthermore, the complex articles may be produced more easily and with greater accuracy using this technology than using reinforced thermoplastics.

A disadvantage of the SMCs and BMCs is that they have a microporous surface and therefore cannot be coated directly, since microbubbles are formed in the coating at from 70 to 80° C. as a result of monomers such as styrene escaping in gaseous form.

The coating material known from the German patent application DE 199 20 799 A1 has made a significant contribution to solving these problems.

The coating material known from the German patent application, curable thermally and with actinic radiation, comprises
(a1) at least one constituent, for example, a urethane (meth)acrylate, containing
   (a11) at least two functional groups, for example, acrylate groups, which serve for crosslinking with actinic radiation, and if desired
   (a12) at least one functional group, especially hydroxyl groups, which are able to undergo thermal crosslinking reactions with a complementary functional group (a22) in the constituent (a2),
      and
(a2) at least one constituent, for example, an isocyanato acrylate, containing
   (a21) at least two functional groups, for example, acrylate groups, which serve for crosslinking with actinic radiation, and
   (a22) at least one functional group, especially an isocyanate group, which is able to undergo thermal crosslinking reactions with a complementary functional group (a12) in the constituent (a1),
      and also, if desired,
(a3) at least one photoinitiator,
(a4) at least one thermal crosslinking initiator,
(a5) at least one reactive diluent curable thermally and/or with actinic radiation,
(a6) at least one coatings additive, and/or
(a7) at least one thermally curable constituent,
   with the proviso that the coating material comprises at least one thermally curable constituent (a7) if the constituent (a1) has no functional group (a12).

For the known coating material it is therefore essential that it comprises a constituent (a2), especially an isocyanato acrylate.

As constituents (a7) the known coating material may comprise thermally curable binders and/or crosslinking agents, examples including blocked polyisocyanates. Non-blocked polyisocyanates are not used as constituents (a7).

Furthermore, the known coating material may comprise electrically conductive pigments as coatings additive (a6).

The known coating material provides coats and seals which without great effort effectively suppress the formation of microbubbles and have a smooth surface, free from structures such as orange peel, that requires no after-treatment, and can be overcoated easily and safely without giving rise to subsequent problems of intercoat adhesion. The overcoatability is retained even when the sealing coat or primer coat on electrically conductive surfaces is overcoated with an electrodeposition coating material. This makes it possible to build the corresponding SMCs or BMCs directly into—for example, uncoated—automobile bodies and to coat them electrophoretically in the same way as the metal parts.

The known coating material and the coatings produced from it, however, despite the high technological level already achieved, require further improvement in terms of sandability and polishability, mechanical flexibility, adhesion, including intercoat adhesion, and overcoatability by electrostatic high-speed rotation methods (ESTA) or by electrophoretic deposition coating, in order to meet the heightened requirements of the market.

Despite all of the advantages possessed by the known coating process, it is still unable fully to meet the heightened requirements of the market with regard to the coating of complexly shaped components. For instance, the curing of the coatings in the shadow zones of the shaped components is frequently inadequate to ensure good sandability and polishability of the coatings, especially of the seals. This is of advantage, however, particularly in the context of the production of particularly high-value SMCs and BMCs.

The German patent applications DE 199 30 665 A1, DE 199 30 067 A1, and DE 199 30 664 A1 or DE 199 24 674 A1 disclose coating materials curable thermally and with actinic radiation and comprising at least one thermally curable constituent having at least two isocyanate-reactive groups, which comprises, mandatorily, copolymers of olefinically unsaturated monomers with 1,1-diphenylethylene and its derivatives. Problems which are associated with the coating of a microporous surface, and possible solutions thereto, are not addressed.

Furthermore, the international patent application WO 98/40170 discloses a wet-on-wet process in which a film of a basecoat material is overcoated with a clearcoat topcoat material, after which the resultant clearcoat film is exposed to actinic radiation before the two films are baked together. The international patent application does not reveal whether the known clearcoat material is able to solve problems associated with the coating of microporous surfaces, or whether it is suitable at all as a seal for SMCs and BMCs.

The German patent application DE 10113884.9, unpublished at the priority date of the present specification, describes a process for coating microporous surfaces which have pores with a size of from 10 to 1500 nm, in which the surfaces in question are coated with at least one coating material curable thermally and with actinic radiation, after which the resultant film(s) is (are) cured thermally and with actinic radiation, the coating material or at least one of the coating materials comprising
(a1) at least one constituent, containing
   (a11) on average per molecule at least two functional groups which contain at least one bond which can be activated with actinic radiation and which serves for crosslinking with actinic radiation, and, if desired,
   (a12) at least one isocyanate-reactive group,
(a2) at least one thermally curable constituent having at least two isocyanate-reactive groups,
   and
(a3) at least one (cyclo)aliphatic polyisocyanate.

The coating material may comprise an electrically conductive pigment, such as a pigment based on mica (Minatec® 40 CM from Merck). The use of saturated aromatic polyisocyanates is not described; instead, the invention is directed expressly only to the (cyclo)aliphatic polyisocyanates.

### PROBLEM OF THE INVENTION

It is an object of the present invention to provide a novel coating material curable thermally and with actinic radiation that no longer has the disadvantages of the prior art but which instead, while fully retaining the technological progress achieved to date, leads to an improved processing window and improved curing properties, especially in the shadow zones of three-dimensional components of complex shape, and which, on a very wide variety of microporous surfaces, provides coatings, especially seals, which possess outstanding sandability and polishability. Moreover, the novel coating material ought to make it possible to carry out thermal curing at temperatures of <120° C. Additionally, the novel coats and seals ought to be of high mechanical flexibility and exhibit very good adhesion to a very wide variety of substrates. Furthermore, their overcoatability ought to be very good. They should also be easy to formulate for electrical conductivity, so that they can also be overcoated using electrostatic high-speed rotation processes (ESTA) or electrophoretic deposition coating techniques. The novel coatings and seals ought also to have particularly good intercoat adhesion.

### SOLUTION PROVIDED BY THE INVENTION

The invention accordingly provides the novel coating material curable thermally and with actinic radiation and comprising
(a1) at least one constituent containing
   (a11) on average per molecule at least two functional groups which contain at least one bond which can be activated with actinic radiation and which serves for crosslinking with actinic radiation and, if desired,
   (a12) at least one isocyanate-reactive group,
(a2) at least one thermally curable constituent having at least two isocyanate-reactive groups,
   and
(a3) at least one aromatic polyisocyanate which is free from functional groups (a11), or a mixture of at least one aromatic polyisocyanate which is free from functional groups (a11) and of at least one (cyclo)aliphatic polyisocyanate which is free from functional groups (a11).

The novel coating material curable thermally and with actinic radiation is referred to below as “coating material of the invention”.

The invention further provides the novel process for coating microporous surfaces, in which the surfaces in question are coated with at least one coating material curable thermally and with actinic radiation, after which the resultant film(s) is (are) cured thermally and with actinic radiation, where the coating material used comprises at least one coating material of the invention.

In the text below, the novel process for coating microporous surfaces is referred to as the “process of the invention”.

In the text below, the novel coated, especially sealed, shaped components are referred to as “shaped components of the invention” and the corresponding SMCs and BMCs are referred to as “compounds of the invention”.

Further subject matter of the invention will emerge from the description.

### ADVANTAGES OF THE INVENTION

In the light of the prior art it was surprising and unforeseeable for the skilled worker that the object on which the invention is based could be achieved with the aid of the coating material, process, shaped components, and compounds of the invention.

A particular surprise was that the coating material and process of the invention without great effort resulted in a seal on microporous surfaces which was free from microbubbling (blistering), which had a smooth surface which was free from structures such as orange peel, which required no after-treatment, and which was easy and safe to overcoat without subsequent problems of intercoat or substrate adhesion.

The processes and coating materials of the invention and the seals produced from them were, surprisingly, able to be formulated very effectively for electrical conductivity. As a result it was possible to coat seals, even when present on substrates which were not electrically conductive, by means of electrostatic high-speed rotation processes (ESTA) or electrophoretic deposition coating techniques.

Among other things, this made it possible to build the shaped components and compounds of the invention directly into uncoated, electrically conductive metal parts, such as automobile bodies, for example, and to coat them electrophoretically in the same way as the metal parts.

An especial surprise, however, was that the coating material of the invention had a particularly broad processing window and could therefore be employed without problems, even under difficult technical and climatic conditions with technologically old equipment and plant and/or at comparatively high or low temperatures and/or comparatively low or high atmospheric humidity, gave improved curing properties, especially in the shadow zones of three-dimensional components of complex shape, and on a very wide variety of microporous surfaces gave coatings, especially seals, which had outstanding polishability and sandability. Moreover, the coatings and seals of the invention were of high mechanical flexibility and showed outstanding adhesion to a very wide variety of substrates and an outstanding intercoat adhesion.

### DETAILED DESCRIPTION OF THE INVENTION

The coating material of the invention is curable thermally and with actinic radiation.

In the context of the present invention the term “thermal curing” denotes the heat-initiated curing of a film of a coating material in which, normally, a separate crosslinking agent is employed. This is commonly referred to by those in the art as external crosslinking.

In the context of the present invention, actinic radiation means electromagnetic radiation such as near infrared (NIR), visible light, UV radiation or X-rays, especially UV radiation, or corpuscular radiation such as electron beams.

Where thermal curing and curing with actinic light are employed together for a single coating material, the term “dual cure” is also used.

The coating material of the invention comprises at least one constituent (a1) containing on average per molecule at least two, in particular at least three, functional groups (a11) which contain at least one, especially one, bond which can be activated with actinic radiation, which serves for crosslinking with actinic radiation, and, if desired, at least one, in particular at least two, isocyanate-reactive group(s) (a12). It is preferred here for the radiation-curable binders to be UV-curable. It is further preferred if component (a1) contains essentially no groups (a12) and with particular preference no groups (a12) at all.

Preferably, the constituent (a1) contains on average per molecule not more than six, in particular not more than five functional groups (a11).

Examples of suitable bonds which can be activated with actinic radiation are carbon-hydrogen single bonds or carbon-carbon, carbon-oxygen, carbon-nitrogen, carbon-phosphorus or carbon-silicon single or double bonds. Of these, the double bonds, especially the carbon-carbon double bonds, are employed with preference.

Highly suitable carbon-carbon double bonds are present, for example, in (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups; ethenylarylene ether, dicyclopentadienyl ether, norbornenyl ether, isoprenyl ether, isopropenyl ether, allyl ether or butenyl ether groups; or ethenylarylene ester, dicyclopentadienyl ester, norbornenyl ester, isoprenyl ester, isopropenyl ester, allyl ester or butenyl ester groups. Of these, (meth)acrylate groups, especially acrylate groups, are of particular advantage and are therefore used with very particular preference in accordance with the invention.

Examples of suitable isocyanate-reactive groups (a12) are thiol groups, primary or secondary amino groups, imino groups or hydroxyl groups, especially hydroxyl groups.

The constituent (a1) is oligomeric or polymeric.

In the context of the present invention, an oligomer is a compound containing in general on average from 2 to 15 basic structures or monomer units. A polymer, in contrast, is a compound containing in general on average at least 10 basic structures or monomer units. Compounds of this kind are also referred to by those in the art as binders or resins.

In contradistinction thereto, a low molecular mass compound in the context of the present invention is a compound which derives substantially only from one basic structure or one monomer unit. Compounds of this kind are also referred to generally by those in the art as reactive diluents.

The polymers or oligomers used as binders (a1) normally have a number average molecular weight of from 500 to 50,000, preferably from 1000 to 5000. They preferably have a double bond equivalent weight of from 400 to 2000, with particular preference from 500 to 900. Furthermore, they have a viscosity at 23° C. of preferably from 250 to 11 000 mPas.

Examples of suitable binders or resins (a1) come from the oligomer and/or polymer classes of the (meth)acryloyl-functional (meth)acrylic copolymers, polyether acrylates, polyester acrylates, polyesters, epoxy acrylates, urethane acrylates, amino acrylates, melamine acrylates, silicone acrylates and phosphazene acrylates, and the corresponding methacrylates. It is preferred to use binders (a1) which are free from aromatic structural units. Preference is therefore given to using urethane (meth)acrylates, phosphazene (meth)acrylates and/or polyester (meth)acrylates, with particular preference urethane (meth)acrylates, especially aliphatic urethane (meth)acrylates.

The urethane (meth)acrylates (a1) are obtained by reacting a diisocyanate or a polyisocyanate with a chain extender from the group of the diols/polyols and/or diamines/polyamines and/or dithiols/polythiols and/or alkanolamines and then reacting the remaining free isocyanate groups with at least one hydroxyalkyl (meth)acrylate or hydroxyalkyl ester of other ethylenically unsaturated carboxylic acids.

The amounts of chain extenders, diisocyanates and/or polyisocyanates, and hydroxyalkyl esters in this case are preferably chosen so that
1.) the ratio of equivalents of the NCO groups to the reactive groups of the chain extender (hydroxyl, amino and/or mercaptyl groups) is between 3:1 and 1:2, preferably being 2:1, and
2.) the OH groups of the hydroxyalkyl esters of the ethylenically unsaturated carboxylic acids are stoichiometric with regard to the remaining free isocyanate groups of the prepolymer formed from isocyanate and chain extender.

It is also possible to prepare the urethane (meth)acrylates by first reacting some of the isocyanate groups of a diisocyanate or polyisocyanate with at least one hydroxyalkyl ester and then reacting the remaining isocyanate groups with a chain extender. In this case too the amounts of chain extender, isocyanate and hydroxyalkyl ester are chosen such that the ratio of equivalents of the NCO groups to the reactive groups of the chain extender is between 3:1 and 1:2, preferably being 2:1, and the ratio of equivalents of the remaining NCO groups to the OH groups of the hydroxyalkyl ester is 1:1. Of course, all of the forms lying between these two processes are also possible. For example, some of the isocyanate groups of a diisocyanate may first be reacted with a diol, after which a further portion of the isocyanate groups may be reacted with the hydroxyalkyl ester, and, subsequently, the remaining isocyanate groups may be reacted with a diamine.

Flexibilizing the urethane (meth)acrylates (a1) is possible, for example, by reacting corresponding isocyanate-functional prepolymers or oligomers with relatively long-chain aliphatic diols and/or diamines, especially aliphatic diols and/or diamines having at least 6 carbon atoms. This flexibilizing reaction may be carried out before or after the addition of acrylic and/or methacrylic acid onto the oligomers and/or prepolymers.

As examples of suitable urethane (meth)acrylates (a1) mention may also be made of the following, polyfunctional aliphatic urethane acrylates that are available commercially:
Crodamer® UVU 300 from Croda Resins Ltd., Kent, Great Britain;
Genomer® 4302, 4235, 4297 or 4316 from Rahn Chemie, Switzerland;
Ebecryl® 284, 294, 8210, 5129 or 1290 or Radcure® IRR 351 from UCB, Drogenbos, Belgium;
Roskydal® LS 2989 or LS 2545 or V94-504 from Bayer AG, Germany;
Viaktin® VTE 6160 from Vianova, Austria; or
Laromer® 8861 from BASF AG, and experimental products developed from it.

Hydroxyl-containing urethane (meth)acrylates (a1) are known, for example, from the patents U.S. Pat. No. 4,634,602 A and U.S. Pat. No. 4,424,252 A.

One example of a suitable polyphosphazene (meth)acrylate (a1) is the phosphazene dimethacrylate from Idemitsu, Japan.

Particular preference is given to Ebecryl® 8210, Laromer® LR8987 and Laromer® UA 19T.

The constituent (a1) is preferably employed in an amount of from 5 to 50% by weight, more preferably from 6 to 45% by weight, with particular preference from 7 to 40% by weight, with very particular preference from 8 to 35% by weight, and in particular from 9 to 30% by weight, based in each case on the solids of the coating material of the invention.

The coating material further comprises at least one thermally curable constituent (a2) containing at least two, in particular at least three, isocyanate-reactive groups. Examples of suitable isocyanate-reactive groups are those described above, in particular hydroxyl groups.

The constituent (a2) is oligomeric or polymeric.

Examples of suitable constituents (a2) are linear and/or branched and/or block, comb and/or random oligomers or polymers, such as (meth)acrylate (co)polymers, polyesters, alkyds, amino resins, polyurethanes, polylactones, polycarbonates, poly-ethers, epoxy resin-amine adducts, (meth)acrylatediols, partially saponified polyvinyl esters or polyureas, of which the (meth)acrylate copolymers, the polyesters, the polyurethanes, the polyethers, and the epoxy resin-amine adducts, but especially the polyesters, are advantageous.

Suitable binders (a2) are sold for example under the trade names Desmophen® 650, 2089, 1100, 670, 1200 or 2017 by Bayer, Priplas or Pripol® by Uniqema, Chempol® polyester or polyacrylate-polyol by CCP, Crodapol® 0-25, 0-85 or 0-86 by Croda, Setal® 1615 or 1715 by Akzo, Dobeckan® IU 080014 by Schenectady-Beck Elektroisoliersysteme, or Formrez® ER417 by Witco.

The binders (a2) preferably have a mass-average molecular weight of from 500 to 10 000 daltons, more preferably from 1000 to 5000 daltons and a hydroxyl number of from 80 to 160 mg KOH/g. Preference is given to using Setal® 1615, Setal® 1715, Desmophen® 650 and Desmophen® 670 as binders (a2).

The fraction of the constituents (a2) in the coating materials may vary widely and is guided by the requirements of the individual case. They are preferably used in an amount of from 5 to 90% by weight, more preferably from 6 to 80% by weight, with particular preference from 7 to 70% by weight, with very particular preference from 8 to 60% by weight, and in particular from 9 to 50% by weight, based in each case on the solids of the coating material.

The coating material further comprises at least one aromatic polyisocyanate (a3) which is free from functional groups (a11).

The aromatic polyisocyanates (a3) contain on average at least 2.0, preferably more than 2.0, and in particular more than 3.0 isocyanate groups per molecule. There is basically no upper limit on the number of isocyanate groups; in accordance with the invention, however, it is of advantage if the number does not exceed 15, preferably 12, with particular preference 10, with very particular preference 8.0, and in particular 6.0.

Examples of suitable aromatic polyisocyanates (a3) are isocyanato-containing polyurethane prepolymers which can be prepared by reacting polyols with an excess of aromatic diisocyanates and which are preferably of low viscosity.

Examples of suitable aromatic diisocyanates are 1,2-, 1,3-, and 1,4-benzene diisocyanate, 2,4- and 2,6-tolylene diisocyanate, 4,4′-biphenylene diisocyanate, bis(4-isocyanatophenyl)methane, 2,2-bis(4-isocyanato-phenyl)propane and the positionally isomeric naphthalene diisocyanates, especially the technical-grade mixtures of 2,4- and 2,6-tolylene diisocyanate.

It is also possible to use aromatic polyisocyanates (a3) containing isocyanurate, biuret, allophanate, iminooxadiazindione, urethane, urea, carbodiimide and/or uretdione groups, prepared conventionally from the above-described aromatic diisocyanates. Examples of suitable preparation processes are known from the patents CA 2,163,591 A, U.S. Pat. No. 4,419,513 A, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0-566 037 A1, U.S. Pat. No. 5,258,482 A1, U.S. Pat. No. 5,290,902 A1, EP 0 649 806 A1, DE 42 29 183 A1, EP 0 531 820 A1, and DE 100 05 228 A1.

Also suitable are the high-viscosity aromatic polyisocyanates (a3) as described in the German patent application DE 198 28 935 A1, or the aromatic polyisocyanate particles surface-deactivated by urea formation and/or blocking, as per the European patent applications EP 0 922 720 A1, EP 1 013 690 A1, and EP 1 029 879 A1.

Additionally suitable as aromatic polyisocyanates (a3) are the adducts, described in the German patent application DE 196 09 617 A1, of polyisocyanates with dioxanes, dioxolanes and oxazolidines containing isocyanate-reactive functional groups which still contain free isocyanate groups.

The aromatic polyisocyanates (a3) may be used together with cycloaliphatic and/or aliphatic polyisocyanates that are free from functional groups (a11), giving the mixture (a3).

The (a11)-free, cycloaliphatic and aliphatic polyisocyanates also contain on average at least 2.0, preferably more than 2.0, and in particular more than 3.0 isocyanate groups per molecule. There is basically no upper limit on the number of isocyanate groups; in accordance with the invention, however, it is of advantage if the number does not exceed 15, preferably 12, with particular preference 10, with very particular preference 8.0, and in particular 6.0.

Examples of suitable aliphatic and cycloaliphatic polyisocyanates are isocyanato-containing polyurethane prepolymers which can be prepared by reacting polyols with an excess of aliphatic and cycloaliphatic diisocyanates and which are preferably of low viscosity.

Examples of suitable aliphatic and cycloaliphatic diisocyanates are isophorone diisocyanate (i.e., 5-isocyanato-1-isocyanatomethyl-1,3,3-trimethylcyclohexane), 5-isocyanato-1-(2-iso-cyanatoeth-1-yl)-1,3,3-trimethylcyclohexane, 5-iso-cyanato-1-(3-isocyanatoprop-1-yl)-1,3,3-trimethylcyclohexane, 5-isocyanato-(4-isocyanatobut-1-yl)-1,3,3-tri-methylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-di-isocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane-2,4′-diisocyanate, trimethylene diisocyanate, tetramethylene diisocyanate, pentamethylene diisocyanate, hexamethylene diisocyanate (HDI), ethylethylene dilsocyanate, trimethylhexane diisocyanate, heptamethylene diisocyanate, methylpentyl diisocyanate (MPDI), nonane triisocyanate (NTI) or diisocyanates derived from dimer fatty acids, as sold under the commercial designation DDI 1410 by Henkel and described in the patents WO 97/49745 and WO 97/49747, especially 2-heptyl-3,4-bis(9-isocyanatononyl)-1-pentyl-cyclohexane, or 1,2-, 1,4- or 1,3-bis(isocyanato-methyl)cyclohexane, 1,2-, 1,4- or 1,3-bis(2-iso-cyanatoeth-1-yl)cyclohexane, 1,3-bis(3-isocyanatoprop-1-yl)cyclohexane, 1,2-, 1,4- or 1,3-bis(4-isocyanatobut-1-yl)cyclohexane or liquid bis(4-isocyanatocyclohexyl)methane with a trans/trans content of up to 30% by weight, preferably 25% by weight, and in particular 20% by weight, as described in the patent applications DE 44 14 032 A1, GB 1220717 A1, DE 16 18 795 A1, and DE 17 93 785 A1, preferably isophorone diisocyanate, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-iso-cyanato-(4-isocyanatobut-1-yl)-1,3,3-trimethylcyclo-hexane, 1-isocyanato-2-(3-isocyanatoprop-1-yl)cyclo-hexane, 1-isocyanato-2-(3-isocyanatoeth-1-yl)cyclo-hexane, 1-isocyanato-2-(4-isocyanatobut-1-yl)cyclo-hexane or HDI, especially HDI.

It is also possible to use aliphatic or cycloaliphatic polyisocyanates containing isocyanurate, biuret, allophanate, iminooxadiazindione, urethane, urea, carbodiimide and/or uretdione groups, prepared conventionally from the above-described aliphatic or cycloaliphatic diisocyanates. Examples of suitable preparation processes are likewise known from the patents CA 2,163,591 A, U.S. Pat. No. 4,419,513, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE-42 29 183 A1, EP 0 531 820 A1, and DE 100 05 228 A1.

Also suitable are the high-viscosity aliphatic or cycloaliphatic polyisocyanates as described in the German patent application DE 198 28 935 A1, or the polyisocyanate particles surface-deactivated by urea formation and/or blocking, as per the European patent applications EP 0 922 720 A1, EP 1 013 690 A1, and EP 1 029 879 A1.

Additionally suitable as aliphatic or cycloaliphatic polyisocyanates are the adducts, described in the German patent application DE 196 09 617 A1, of aliphatic or cycloaliphatic polyisocyanates with dioxanes, dioxolanes and oxazolidines containing isocyanate-reactive functional groups, which still contain free isocyanate groups.

The aromatic polyisocyanates (a3) are preferably selected from the group consisting of polyisocyanates based on the technical-grade mixtures of 2,4- and 2,6-tolylene diisocyanate.

The (cyclo)aliphatic polyisocyanates are preferably selected from the group consisting of polyisocyanates based on hexamethylenediisocyanate and based on isophorone diisocyanate.

A minor fraction of the aromatic polyisocyanates (a3) and/or of the (cyclo)aliphatic polyisocyanates may be blocked using customary and known blocking agents. By a minor fraction are meant amounts which advantageously vary, but do not characterize, the technological profile of properties of the polyisocyanates (a3). Preferably from 5 to 80 mol %, in particular from 20 to 45 mol % of the aromatic polyisocyanates (a3) and/or of the (cyclo)aliphatic polyisocyanates are blocked. The (cyclo)aliphatic polyisocyanate hardeners preferably have an NCO content of from 15 to 25%. The aromatic polyisocyanate hardeners preferably have an NCO content of from 10 to 15%.

The amount of aromatic polyisocyanates (a3) or of the mixture (a3) comprising at least one aromatic polyisocyanate (a3) and at least one aliphatic and/or cycloaliphatic polyisocyanate in the coating materials of the invention may vary very widely and is guided by the requirements of the individual case, in particular by the amount of isocyanate-reactive groups in the constituents (a2) and, where appropriate, (a1). Said amount is preferably from 5 to 60% by weight, more preferably from 5 to 55% by weight, with particular preference from 5 to 50% by weight, with very particular preference from 5 to 45% by weight, and in particular from 5 to 40% by weight, based in each case on the solids of the coating material of the invention.

The proportion of aromatic polyisocyanate (a3) to (cyclo)aliphatic polyisocyanate in the mixture (a3) is from 95:5 to 5:95, preferably from 85:15 to 15:85, and in particular from 80:20 to 20:80.

The coating material of the invention may further comprise at least one pigment and/or filler. The fillers and pigments in question may comprise color and/or effect pigments, fluorescent pigments, electrically conductive pigments and/or magnetically shielding pigments, metal powders, scratchproofing pigments, organic dyes, organic and inorganic, transparent or opaque fillers and/or nanoparticles.

Where the coating material of the invention is used to produce electrically conductive seals, it preferably comprises at least one electrically conductive pigment and/or at least one electrically conductive filler.

Examples of suitable effect pigments are metal flake pigments such as commercially customary aluminum bronzes, aluminum bronzes chromated in accordance with DE 36 36 183 A1, and commercially customary stainless steel bronzes, and also nonmetallic effect pigments, such as pearlescent pigments and interference pigments, for example, platelet-shaped effect pigments based on iron oxide with a color from pink to brownish red, or liquid-crystalline effect pigments. For further details, attention is drawn to Römpp Lexikon Lacke und Druckfarben, Georg Thieme Verlag, 1998, page 176, “Effect pigments” and pages 380 and 381, “Metal oxide-mica pigments” to “Metal pigments”, and to the patent applications and patents DE 36 36 156 A1, DE 37 18 446 A1, DE 37 19 804 A1, DE. 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A, and U.S. Pat. No. 5,244,649 A.

Examples of suitable inorganic color pigments are white pigments such as titanium dioxide, zinc white, zinc sulfide or lithopones; black pigments such as carbon black, iron manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chrome orange; or yellow iron oxide, nickel titanium yellow, chrome titanium yellow, cadmium sulfide, cadmium zinc sulfide, chrome yellow or bismuth vanadate.

Examples of suitable organic color pigments are monoazo pigments, bisazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments or aniline black.

For further details, attention is drawn to Römpp Lexikon Lacke und Druckfarben, Georg Thieme Verlag, 1998, pages 180 and 181, “Iron blue pigments” to “Black iron oxide”, pages 451 to 453, “Pigments” to “Pigment volume concentration”, page 563, “Thioindigo pigments”, page 567, “Titanium dioxide pigments”, pages 400 and 467, “Naturally occurring pigments”, page 459, “Polycyclic pigments”, page 52, “Azomethine pigments”, “Azo pigments”, and page 379, “Metal complex pigments”.

Examples of fluorescent pigments (daylight fluorescent pigments) are bis(azomethine) pigments.

Examples of suitable electrically conductive pigments are, for example, pigments which at pigment contents of from 20 to 25% by weight, based on the total solids of the composition, produce a hiding power over black/white contrast from a dry film thickness of 60 μm. These pigments are preferably transparent for actinic radiation, especially UV radiation.

Examples of highly suitable electrically conductive pigments of this kind are pigments based on mica which are coated with metal oxide layers, especially antimony tin mixed oxide layers. Particularly suitable conductive mica pigments are sold by the company Merck under the brand name Minatec® 40 CM, 31 CM or 30 CM (“Conductive Mica”).

Examples of magnetically shielding pigments are pigments based on iron oxides or chromium dioxide.

Examples of suitable metal powders are powders of metals and metal alloys such as aluminum, zinc, copper, bronze or brass.

Suitable soluble organic dyes are lightfast organic dyes with little or no tendency to migrate from the coating material or from the coatings produced from it. The migration tendency can be estimated by the skilled worker on the basis of his or her general knowledge in the art and/or determined by means of simple preliminary range-finding tests, as part of tinting experiments, for example.

Examples of suitable organic and inorganic fillers are chalk, calcium sulfates, barium sulfate, silicates such as talc, mica or kaolin, silicas, oxides such as aluminum hydroxide or magnesium hydroxide, or organic fillers such as polymer powders, especially those of polyamide or polyacrylonitrile. For further details, attention is drawn to Römpp Lexikon Lacke und Druckfarben, Georg Thieme Verlag, 1998, pages 250 ff., “Fillers”.

Examples of suitable transparent fillers are those based on silica, alumina or zirconium oxide, but especially nanoparticles on this basis.

Particular preference is given to fillers which are transparent to actinic radiation, especially UV radiation, such as Mircavor® 20, Mistron® Monomix and Blancfix® N or F.

With very particular preference, the electrically conductive coating materials of the invention comprise at least one of the above-described electrically conductive mica pigments and at least one of the above-described UV-transparent fillers.

The amount of the above-described pigments and/or fillers in the coating material of the invention may vary very widely and is guided by the requirements of the individual case. Based on the solids of the coating material, it is preferably from 5 to 50, more preferably from 5 to 45, with particular preference from 5 to 40, with very particular preference from 5 to 35, and in particular from 5 to 30% by weight.

The coating material of the invention may further comprise at least one tackifier. The term tackifier refers to polymeric adhesives additives which increase the tack, i.e., the inherent stickiness or self-adhesion, of the adhesives so that after a short period of gentle pressure they adhere firmly to surfaces (cf. Ullmann's Encyclopedia of Industrial Chemistry, CD-ROM, Wiley VCH, Weinheim, 1997, “Tackifier”).

Examples of suitable tackifiers are high-flexibility resins selected from the group consisting of
homopolymers of alkyl(meth)acrylates, especially alkyl acrylates, such as poly(isobutyl acrylate) or poly(2-ethylhexyl acrylate), which are sold under the brand name Acronal® by BASF Aktiengesellschaft, Elvacite® by Dupont, Neocryl® by Avecia, and Plexigum® by Roehm;
linear polyesters, as are commonly used for coil coating and sold, for example, under the brand name Dynapol® by Dynamit Nobel, Skybond® by SK Chemicals, Japan, or under the commercial designation LTW by Degussa; linear difunctional oligomers, curable with actinic radiation, with a number average molecular weight of more than 2000, in particular from 3000 to 4000, based on polycarbonatediol or polyester-diol, which are sold under the designation CN 970 by Craynor or the brand name Ebecryl® by UCB;
linear vinyl ether homopolymers and copolymers based on ethyl, propyl, isobutyl, butyl and/or 2-ethylhexyl vinyl ether, sold under the brand name Lutonal® by BASF Aktiengesellschaft; and
nonreactive urethane urea oligomers, which are prepared from bis(4,4-isocyanatophenyl)methane, N,N-dimethylethanolamine and diols such as propanediol, hexanediol or dimethylpentanediol and are sold, for example, by Swift Reichold under the brand name Swift Range® or by Mictchem Chemicals under the brand names Surkopack® or Surkofilm®.

The tackifiers are used preferably in an amount of from 0.1 to 10% by weight, more preferably from 0.2 to 9% by weight, with particular preference from 0.3 to 8% by weight, with very particular preference from 0.4 to 7% by weight, and in particular 0.56% by weight, based in each case on the solids of the coating material of the invention.

The coating material of the invention may further comprise at least one photoinitiator. If the coating material is to be crosslinked with UV radiation, it is generally necessary to use a photoinitiator. Where they are used, they are present in the coating material preferably in fractions of from 0.1 to 10% by weight, more preferably from 0.2 to 8% by weight, with particular preference from 0.3 to 7% by weight, with very particular preference from 0.4 to 6% by weight, and in particular from 0.5 to 5% by weight, based in each case on the solids of the coating material.

Examples of suitable photoinitiators are those of the Norrish II type, whose mechanism of action is based on an intramolecular variant of the hydrogen abstraction reactions as occur diversely in the case of photochemical reactions (by way of example, reference may be made here to Römpp Chemie Lexikon, 9th, expanded and revised edition, Georg Thieme Verlag, Stuttgart, Vol. 4, 1991) or cationic photoinitiators (by way of example, reference may be made here to Römpp Lexikon Lacke und Druckfarben, Georg Thieme Verlag, Stuttgart, 1998, pages 444 to 446), especially benzophenones, benzoins or benzoin ethers, or phosphine oxides. It is also possible to use, for example, the products available commercially under the names Irgacure® 184, Irgacure® 1800 and Irgacure® 500 from Ciba Geigy, Grenocure® MBF from Rahn, and Lucirin® TPO from BASF AG.

Besides the photoinitiators, customary sensitizers such as anthracene may be used in effective amounts.

Furthermore, the coating material of the invention may comprise at least one thermal crosslinking initiator. At from 80 to 120° C., these initiators form radicals which start the crosslinking reaction. Examples of thermolabile free-radical initiators are organic peroxides, organic azo compounds or C—C-cleaving initiators such as dialkyl peroxides, peroxocarboxylic acids, peroxodicarbonates, peroxide esters, hydroperoxides, ketone peroxides, azo dinitriles or benzpinacol silyl ethers. C—C-cleaving initiators are particularly preferred since their thermal cleavage does not result in the formation of any gaseous decomposition products which might lead to defects in the seal. Where used, their amounts are generally from 0.1 to 10% by weight, preferably from 0.5 to 8% by weight, and in particular from 1 to 5% by weight, based in each case on the solids of the coating material.

Moreover, the coating material of the invention may comprise at least one reactive diluent curable with actinic-radiation and/or thermally.

Examples of suitable thermally curable reactive diluents are positionally isomeric diethyloctanediols or hydroxyl-containing hyperbranched compounds or dendrimers, as described in the patent applications DE 198 09 643 A1, DE 198 40 605 A1, and DE 198 05 421 A1.

Further examples of suitable reactive diluents are polycarbonatediols, polyesterpolyols, poly(meth)acrylatediols or hydroxyl-containing polyadducts.

Examples of suitable reactive solvents which may be used as reactive diluents are butyl glycol, 2-methoxypropanol, n-butanol, methoxybutanol, n-propanol, ethylene glycol monomethyl ether, ethylene glycol monoethyl ether, ethylene glycol monobutyl ether, diethylene glycol monomethyl ether, diethylene glycol monoethyl ether, diethylene glycol diethyl ether, diethylene glycol monobutyl ether, trimethylolpropane, ethyl 2-hydroxypropionate or 3-methyl-3-methoxybutanol and also derivatives based on propylene glycol, e.g., ethoxyethyl propionate, isopropoxypropanol or methoxypropyl acetate.

As reactive diluents which may be crosslinked with actinic radiation, use is made, for example, of (meth)acrylic acid and esters thereof, maleic acid and its esters, including monoesters, vinyl acetate, vinyl ethers, vinylureas, and the like. Examples that may be mentioned include alkylene glycol di(meth)acrylate, polyethylene glycol di(meth)acrylate, 1,3-butanediol di(meth)acrylate, vinyl(meth)acrylate, allyl(meth)acrylate, glycerol tri(meth)acrylate, trimethylolpropane tri(meth)acrylate, trimethylolpropane di(meth)acrylate, styrene, vinyltoluene, divinylbenzene, pentaerythritol tri(meth)acrylate, pentaerythritol tetra(meth)acrylate, dipentaerythritol penta(meth)acrylate, dipropylene glycol di(meth)acrylate, hexanediol di(meth)acrylate, ethoxyethoxyethyl acrylate, N-vinylpyrrolidone, phenoxyethyl acrylate, dimethylaminoethyl acrylate, hydroxyethyl(meth)acrylate, butoxyethyl acrylate, isobornyl(meth)acrylate, dimethylacrylamide and dicyclopentyl acrylate, the long-chain linear diacrylates described in EP 0 250 631 A1 with a molecular weight of from 400 to 4000, preferably from 600 to 2500. For example, the two acrylate groups may be separated by a polyoxybutylene structure. It is also possible to use 1,12-dodecyl diacrylate and the reaction product of 2 moles of acrylic acid with one mole of a dimer fatty alcohol having generally 36 carbon atoms. Mixtures of the aforementioned monomers are also suitable.

Further examples of suitable reactive diluents curable with actinic radiation are those described in Römpp Lexikon Lacke und Druckfarben, Georg Thieme Verlag, Stuttgart, N.Y., 1998, on page 491 under the entry on “Reactive diluents”.

Where used, the reactive diluents are employed in an amount of preferably from 2 to 70% by weight, with particular preference from 10 to 65% by weight, and in particular from 15 to 50% by weight, based in each case on the solids of the coating material.

The coating material of the invention may further comprise at least one customary and known isocyanato acrylate. Examples of suitable isocyanato acrylates are described in the European patent application EP 0 928 800 A1. Said isocyanato acrylates may also, however, have been blocked with the blocking agents known from the American patents U.S. Pat. No. 4,444,954 A and U.S. Pat. No. 5,972,189 A.

The coating material of the invention may further comprise at least one crosslinking agent as is commonly employed for thermal crosslinking in one-component systems.

Examples of suitable crosslinking agents are amino resins, as described for example in Römpp Lexikon Lacke und Druckfarben, Georg Thieme Verlag, 1998, page 29, “Amino resins”, in the textbook “Lackadditive” [Additives for coatings] by Johan Bieleman, Wiley-VCH, Weinheim, N.Y., 1998, pages 242 ff., in the book “Paints, Coatings and Solvents”, second, completely revised edition, edited by D. Stoye and W. Freitag, Wiley-VCH, Weinheim, N.Y., 1998, pages 80 ff., in the patents U.S. Pat. No. 4,710,542 A1 and EP-B-0 245 700 A1, and also in the article by B. Singh and coworkers, “Carbamylmethylated Melamines, Novel Crosslinkers for the Coatings Industry”, in Advanced Organic Coatings Science and Technology Series, 1991, Volume 13, pages 193 to 207; carboxyl-containing compounds or resins, as described for example in patent DE 196 52 813 A1; and compounds or resins containing epoxide groups, as described for example in the patents EP 0 299 420 A1, DE 22 14 650 B1, DE 27 49 576 B1, U.S. Pat. No. 4,091,048 A1, and U.S. Pat. No. 3,781,379 A1.

The coating material of the invention may further comprise water and/or at least one inert organic or inorganic solvent.

Examples of inorganic solvents are liquid nitrogen and supercritical carbon dioxide.

Examples of suitable organic solvents are the high-boiling (“long”) solvents or low boiling solvents commonly used in the paints sector, such as ketones such as methyl ethyl ketone, methyl isoamyl ketone or methyl isobutyl ketone, esters such as ethyl acetate, butyl acetate, ethyl ethoxypropionate, methoxypropyl acetate or butyl glycol acetate, ethers such as dibutyl ether or ethylene glycol, diethylene glycol, propylene glycol, dipropylene glycol, butylene glycol or dibutylene glycol dimethyl, diethyl or dibutyl ether, N-methylpyrrolidone or xylenes or mixtures of aromatic and/or aliphatic hydrocarbons such as Solventnaphtha®, petroleum spirit 135/180, dipentenes or Solvesso® (cf. also “Paints, Coatings and Solvents”, Dieter Stoye and Werner Freitag (editors), Wiley-VCH, 2nd edition, 1998, pages 327 to 349).

The coating material of the invention may further comprise at least one customary and known coatings additive in effective amounts, i.e., in amounts of preferably up to 40% by weight, with particular preference up to 30% by weight, and in particular up to 20% by weight, based in each case on the solids of the coating material.

Examples of suitable coatings additives are UV absorbers, light stabilizers, free-radical scavengers, crosslinking catalysts such as dibutyltin dilaurate or lithium decanoate, slip additives, polymerization inhibitors, defoamers, emulsifiers, wetting agents, adhesion promoters leveling agents, film-forming auxiliaries such as cellulose derivatives, flame retardants, sag control agents, rheology control additives or flatting agents.

The coating material of the invention may be present in different forms.

For instance, given an appropriate choice of its above-described constituents (a1), (a2), and (a3), and of the further constituents that may be present, it may be present in the form of a liquid coating material which is substantially free from organic solvents and/or water (100% system). Alternatively, the coating material may comprise a solution or dispersion of the above-described constituents in water and/or organic solvents. It is a further advantage of the aqueous and of the conventional coating material that solids contents of up to 80% by weight, based on the coating material, may be formulated.

Moreover, given an appropriate choice of its constituents as described above, the coating material of the invention may be a powder clearcoat material. This powder clearcoat material may if desired be dispersed in water to give a powder slurry clearcoat material.

The coating material of the invention, if permitted by the reactivity of its constituents (a1) and (a2) on the one hand and (a3) on the other, may be a one-component system. If, however, there is a risk of premature thermal crosslinking of the abovementioned constituents, it is advisable to configure the coating material of the invention as a two-component or multicomponent system, in which at least the constituent (a3) is stored separately from the other constituents and is not added to them until shortly before use in the process of the invention.

The method of preparing the coating material of the invention has no special features but is instead carried out conventionally by mixing of the above-described constituents in appropriate mixing equipment, such as stirred tanks, dissolvers, Ultraturrax, inline dissolvers, toothed-wheel dispersers, pressure release homogenizers, microfluidizers, stirred mills or extruders. It should be ensured here that no premature crosslinking takes place induced by visible light or other actinic radiation.

The process of the invention is used for coating, especially sealing, microporous surfaces having generally pores with a size of from 10 to 1500, preferably from 20 to 1200, and in particular from 50 to 1000 nm. The surfaces here may be electrically conductive or electrically insulating.

The electrically conductive surfaces are metallic or nonmetallic. Nonmetallic conductive surfaces consist, for example, of electrically conductive ceramic materials, especially oxides and chalcogenides, or electrically conductive polymers.

The microporous surfaces preferably comprise the surfaces of shaped components made from materials selected from the group consisting of wood, glass, leather, plastics, minerals, foams, fiber materials and fiber-reinforced materials, metals, and metalized materials.

Foams to DIN 7726: 1982-05 are materials which have open and/or closed cells distributed over their entire mass and which have a density lower than that of the framework substance. Preference is given to elastic and flexible foams to DIN 53580 (cf. also Römpp Lexikon Chemie, CD-ROM: Version 2.0, Georg Thieme Verlag, Stuttgart, N.Y., 1999, “Foams”).

The metalized materials preferably comprise wood, glass, leather, plastics, minerals, foams, fiber materials, and fiber reinforced materials.

The minerals preferably comprise fired and unfired clay, ceramic, natural stone or artificial stone or cement, the fiber materials preferably comprise glass fibers, ceramic fibers, carbon fibers, textile fibers, polymer fibers or metal fibers, and composites of these fibers, and the fiber reinforced materials preferably comprise plastics reinforced with the aforementioned fibers.

The metals preferably comprise reactive utility metals, especially iron, steel, zinc, aluminum, magnesium, titanium, and the alloys of at least two of these metals.

The shaped components are preferably
components for automotive construction, especially parts of motor vehicle bodies, such as protective plates, fenders, spoilers, hoods, doors or lamp reflectors,
sanitary articles and household implements,
components for buildings, inside and outside,
components for doors, windows, and furniture,
industrial components, including coils, containers, and radiators, and also
electrical components, including wound articles, such as coils of electric motors.

In particular, however, the shaped components are SMCs (sheet molded compounds) or BMCs (bulk molded compounds). SMCs and BMCs may have a wide-ranging technological property profile, depending on manufacturer, and a wide variety of properties. “Semi-finished” (i.e., the mixture not yet processed in the mold) SMCs and BMCs contain unsaturated polyesters, fillers of all kinds, glass fibers, and additives such as inhibitors for improving the shelf life and initiators for the polymerization, and also mold release agents. Through the choice of pigments, SMCs/BMCs can also be formulated for conductivity. On the basis of the fillers, SMCs/BMCs are able to draw moisture. Depending on the requirements, viscosity, density, strength, and the like are set by way of the precise composition during the processing of the semi-finished product to give the molding. This results automatically in a wide range of possible porosity, concentration of additive on the surface of the molding, and structure, these features generally having an adverse impact on the adhesion of coatings.

It is a particular merit of the coating materials and process of the invention that the seals and coatings of the invention adhere particularly firmly to a wide variety of SMCs and BMCs.

In accordance with the process of the invention, for the purpose of producing the shaped components and compounds of the invention the coating material for use in accordance with the invention is applied to the surface of the shaped components, especially the BMCs and SMCs.

In the context of the process of the invention it is possible to apply one or more coats of the coating material of the invention. Where two or more coats are applied, coating materials of the invention differing in their material composition may be used. In the great majority of cases, however, the target profile of properties of the shaped components and compounds of the invention is achieved with one coating of a coating material.

The coat of the coating material is applied in a wet film thickness such that, after curing, the dry film thickness of the seal in the finished shaped component or compound of the invention is from 10 to 100, preferably from 10 to 75, with particular preference from 10 to 55, and in particular from 10 to 50 μm.

The application of the coating material of the invention may take place by any customary application method, such as spraying, brushing, knife coating, flow coating, dipping or rolling, for example. It is preferred to employ spray application methods, such as compressed air spraying, airless spraying, high-speed rotation, electrostatic spray application (ESTA), for example, alone or in conjunction with hot spray application such as hot air spraying, for example. Application may take place at temperatures of max. 70 to 80° C., so that appropriate application viscosities are attained without any change or damage to the coating material or its overspray (which may be intended for reprocessing) during the short period of thermal stress. Hot spraying, for instance, may be configured in such a way that the coating material is heated only very briefly in the spray nozzle or shortly before the spray nozzle.

The spray booth used for application may be operated, for example, with a circulation system, which may be temperature-controllable, and which is operated with an appropriate absorption medium for the overspray, an example of such a medium being the coating material of the invention itself.

Preferably, application is made under illumination with visible light with a wavelength of more than 550 μm, or in the absence of light. By this means, material alteration or damage to the coating material of the invention or its overspray is avoided.

The application methods described above may of course also be used to overcoat the coatings or seals of the invention.

In accordance with the invention, following its application, the coat of the coating material of the invention is cured thermally and with actinic radiation, to give the seal of the invention.

Curing may take place after a certain rest period. This period may have a duration of from 30 s to 2 h, preferably from 1 min to 1 h, and in particular from 1 min to 30 min. The rest period is used, for example, for leveling and devolatilization of the coat of the coating material or for the evaporation of volatile constituents such as solvents, water or carbon dioxide, if the coating material was applied using supercritical carbon dioxide as solvent. The drying which takes place in the rest period may be shortened and/or assisted by the application of elevated temperatures up to 80° C., provided this does not entail any damage or alteration to the coat of the coating material, such as premature complete crosslinking.

Curing takes place preferably with UV radiation or electron beams. If desired, it may be supplemented by or conducted with actinic radiation from other radiation sources. In the case of electron beams, it is preferred to operate under an inert-gas or oxygen-depleted atmosphere. This may be ensured, for example, by supplying carbon dioxide and/or nitrogen directly to the surface of the coat of the coating material of the invention. In the case of curing with UV radiation as well, it is possible to operate under inert gas or an oxygen-depleted atmosphere in order to prevent the formation of ozone.

Curing with actinic radiation is carried out using the customary and known radiation sources and optical auxiliary measures. Examples of suitable radiation sources are high or low pressure mercury vapor lamps or electron beam sources. The arrangement of these sources is known in principle and may be adapted to the circumstances of the workpiece and the process parameters. In the case of workpieces of complex shape, as are envisaged for automobile bodies, the regions not accessible to direct radiation (shadow regions) such as cavities, folds and other structure undercuts may be (partially) cured using pointwise, small-area or all-round emitters, in conjunction with an automatic movement means for the irradiation of cavities or edges.

The equipment and conditions for these curing methods are described, for example, in R. Holmes, U. V. and E. B. Curing Formulations for Printing Inks, Coatings and Paints, SITA Technology, Academic Press, London, United Kingdom 1984, in the German patent application DE 198 18 735 A1, column 10, line 31 to column 11, line 22, by R. Stephen Davidson in “Exploring the Science, Technology and Applications of U. V. and E. B. Curing” Sita Technology Ltd., London, 1999, Chapter 1, “An Overview”, page 16, FIG. 10, or by Dipl.-Ing. Peter Klamann in “eltosch System-Kompetenz, UV-Technik, Leitfaden für Anwender”, page 2, October 1998.

Curing here may take place in stages, i.e., by multiple exposure to light or actinic radiation. This may also be done alternately, i.e., by curing in alternation with UV radiation and with electron beams.

The thermal curing as well has no special features in terms of its methodology but instead takes place in accordance with the customary and known methods such as heating in a forced air oven or exposure to IR lamps. As with the curing with actinic radiation, thermal curing may also take place in stages. Advantageously, the thermal curing takes place at a temperature up to 120° C., with particular preference up to 110° C., with very particular preference up to 100° C., and in particular up to 90° C., preferably for a period of from 1 min up to 2 h, preferably 2 min up to 1 h, and in particular from 3 to 30 min.

The thermal curing and curing with actinic radiation may be employed simultaneously or alternately. Where the two curing methods are used in alternation it is possible, for example, to commence with thermal curing and to end with actinic radiation curing. In other cases it may prove advantageous to commence with actinic radiation curing and to end with it as well. The skilled worker is able to determine the curing method most advantageous for the particular case in hand on the basis of his or her general knowledge in the art, possibly with the assistance of simple preliminary tests.

The films of the coating materials of the invention may be cured outstandingly even in the shadow zones of the shaped components.

It is a very particular advantage of the process of the invention that the shaped components and SMCs and BMCs coated with the coating material of the invention, following drying and exposure to actinic radiation, preferably in an incompletely cured state, may be immediately overcoated, which for the production of the shaped components of the invention and for the SMCs and BMCs of the invention signifies a significant time, energy and cost saving.

In one particularly advantageous embodiment of the process of the invention an electrically non-conducting coating material of the invention is applied to the SMCs and BMCs. The applied films are partially cured with actinic radiation, especially UV radiation. The part-cured films are then coated with a customary electrically conductive two-component coating material (2K conductive primer) or with an electrically conductive coating material of the invention, particularly a 2K conductor primer, after which the two films are jointly cured thermally.

Furthermore, the shaped components and SMCs and BMCs coated with the coating material of the invention, after drying and exposure to actinic radiation, may be subjected to thermal aftercuring, at 90° C. for 20 minutes, for example, after which the shaped components of the invention and the SMCs and BMCs of the invention may be stored in stacks before further processing, especially overcoating, without any problems of sticking or deformation.

The electrically conductive coatings and seals of the invention are outstandingly suitable for the application of further coating materials by means of electrostatic high-speed rotation (ESTA) or by means of electrophoretic application techniques, such as anodic or cathodic electrodeposition coating.

The shaped components and compounds of the invention obtained by the procedure of the invention show no signs whatsoever of microbubbles (blisters). Their surface is smooth and free from defects. Their thermal stability is outstanding: even under thermal loads at high temperatures for several hours, the surface is not damaged. The shaped components and compounds of the invention may therefore be built directly into uncoated automobile bodies, for example, and may be coated—electrophoretically as well—on the line together with them.

The coatings and seals obtained by the procedure of the invention exhibit outstanding flexibility and outstanding adhesion to a very wide variety of substrates, so that the shaped components and compounds of the invention may be deformed without problems and without mechanical damage to the coatings present thereon. Furthermore, they possess outstanding sandability and polishability, making it very easy to repair sites of damage.

The coatings and seals may be overcoated outstandingly with all customary and known, aqueous or conventional, liquid or solid, water-free and solvent-free, physically or thermally curable and/or actinic-curable primers, electrocoats, surfacers or antistonechip primers, solid-color and/or effect topcoats or basecoats, and also clearcoats. The resultant multicoat systems exhibit outstanding intercoat adhesion.

### EXAMPLES

### Preparation Examples 1 and 2

The Preparation of Electrically Conductive Coating Materials

For the preparation of the coating materials of Preparation Examples 1 and 2, first of all a mixing varnish was prepared by mixing and homogenizing the following constituents in the order stated:
32 parts by weight of a saturated polyester having an OH content of 4.4%, based on solids, a solids content of 71-73%, an acid number of from 6.5 to 9.8, a viscosity from 4.0 to 5.8 Pas at 23° C. and 100 s⁻¹ (Setal® 1715 from Akzo),
15 parts by weight of an acrylated aliphatic urethane oligomer having an OH number of 76-90, a solids content of 100%, a theoretical functionality of 3.9, and a Höppler viscosity of about 4500 mPas at 25° C. (Ebecryl® 8210 from UCB),
0.47 part by weight of a rheology aid (Bentone® SD2 from Rheox),
0.24 part by weight of a dispersant (Antiterra® U from Byk),
4.03 parts by weight of xylene,
2 parts by weight of butyl acetate,
6.8 parts by weight of a commercial filler (microcrystalline talc, Mistron® Monomix from Luzenac),
10.2 parts by weight of ethyl ethoxypropionate (EEP),
15.8 parts by weight of an electrically conductive mica pigment (Minatec® 40 CM from Merck),
2 parts by weight of a tackifier (polyester tackifier resin LTW from Degussa, 60% strength in xylene),
0.2 part by weight of a lithium salt catalyst (Nuodex® LI from OMG),
0.1 part by weight of a photoinitiator (Irgacure® 819 from Ciba Specialty Chemicals),
0.96 part by weight of a photoinitiator (Lucirin® TPO from BASF Aktiengesellschaft), and
10.2 parts by weight of EEM.

The coating material of Preparation Example 1 was prepared shortly before application by mixing and homogenizing 100 parts by weight of the mixing varnish and 10 parts by weight of a 75% by weight solution of a technical-grade mixture of 2,4- and 2,6-tolylene diisocyanate in ethyl acetate (Desmodur® L 75 from Bayer AG; isocyanate content: 11.5 to 13%).

The coating material of Preparation Example 2 was prepared shortly before application by mixing and homogenizing 100 parts by weight of the mixing varnish, 5 parts by weight of a 75% by weight solution of a technical-grade mixture of 2,4- and 2,6-tolylene diisocyanate in ethyl acetate (Desmodur® L 75 from Bayer AG; isocyanate content: 11.5 to 13%), and 5 parts by weight of a 90% by weight solution of the trimer of hexamethylene diisocyanate in Solventnaphtha® (Desmodur® N3300 from Bayer, diluted to give a 90% solution).

### Preparation Examples 3 and 4

The Preparation of Nonconductive Coating Materials

For the preparation of the coating materials of Preparation Examples 3 and 4, first of all a mixing varnish was prepared by mixing and homogenizing the following constituents in the order stated:
35.2 parts by weight of a saturated polyester (Setal® 1715 from Akzo, 75% in Solventnaphtha®/xylene—see Preparation Examples 1 and 2),
16.3 parts by weight of an acrylated aliphatic urethane oligomer (Ebecryl® 8210 from UCB—see Preparation Examples 1 and 2),
0.51 part by weight of a rheology aid (Bentone® SD2 from Rheox),
0.26 part by weight of a dispersant (Antiterra® U from Byk),
4.4 parts by weight of xylene,
5.6 parts by weight of EEP,
0.5 part by weight of a leveling agent (Disparlon® LC 900 from Kusutomo Chemicals),
24.7 parts by weight of a white mica pigment (Mircavor® 20 from dam mineraux),
2.2 parts by weight of a tackifier (polyester tackifier resin LTW from Degussa, 60% strength in xylene),
0.22 part by weight of a lithium salt catalyst (Nuodex® LI from OMG),
0.093 part by weight of a photoinitiator (Irgacure® 819 from Ciba Specialty Chemicals),
0.88 part by weight of a photoinitiator (Lucirin® TPO from BASF Aktiengesellschaft),
5.72 parts by weight of EEM, and
3.427 parts by weight of butyl acetate.

The coating material of Preparation Example 3 was prepared shortly before application by mixing and homogenizing 100 parts by weight of the mixing varnish and 10 parts by weight of a 75% by weight solution of a technical-grade mixture of 2,4- and 2,6-tolylene diisocyanate in ethyl acetate (Desmodur® L 75 from Bayer AG; isocyanate content: 11.5 to 13%).

The coating material of Preparation Example 4 was prepared shortly before application by mixing and homogenizing 100 parts by weight of the mixing varnish, 5 parts by weight of a 75% by weight solution of a technical-grade mixture of 2,4- and 2,6-tolylene diisocyanate in ethyl acetate (Desmodur® L 75 from Bayer AG; isocyanate content: 11.5 to 13%), and 5 parts by weight of a 90% by weight solution of the trimer of hexamethylene diisocyanate in Solventnaphtha® (Desmodur® N3300 from Bayer, diluted to give a 90% solution).

### Examples 1 to 4

The Production of Seals on SMCs and BMCs

For Examples 1 to 4, the coating materials of Preparation Examples 1 to 4 were applied by means of customary pneumatic or electrostatic techniques to a very wide variety of porous surfaces, especially those of SMCs and BMCs.

Following application, the resulting films of the coating materials were flashed off and dried and then exposed to UV radiation. This gave partially cured, electrically conductive seals having a dry film thickness of between 10 and 50 μm. They were notable for the complete absence of microbubbles. They possessed outstanding flexibility and hardness and were immediately overcoatable with commercially customary primers or electrocoat materials. Following complete curing the resulting primers and electrocoats adhered outstandingly to the seals, which in turn adhered outstandingly to the substrates.

In accordance with another variant, following application the resulting films of the coating materials of Preparation Examples 1 and 2 were flashed off and dried and then exposed to UV radiation. They were subsequently cured thermally at 90° C. for 20 minutes. This gave cured, electrically conductive (Examples 1 and 2) and nonconductive (Examples 3 and 4) seals having a dry film thickness of between 10 and 50 μm. They were notable for the complete absence of microbubbles. They were fully cured even in the shadow zones of the shaped components, especially the SMCs and BMCs. They possessed outstanding flexibility and hardness. The coated shaped components, especially the SMCs and BMCs, were storable in stacks without problems prior to further processing, without any mechanical damage to the seals and without them sticking. The overcoatability of the seals and the adhesion between them and the overlying coats Were outstanding. Likewise, the adhesion of the seals to the substrates was outstanding: the adhesion was measured by means of the tests, known to those in the art, of Volvo and Daimler Chrysler, test specification DBL5416. The adhesion in the cross-hatch test with adhesive-tape tear-off (DBL5416, 6.4=DIN 53151) was outstanding: in all cases, rating GT0.

1. A coating material curable thermally and with actinic radiation, comprising
(a1) at least one constituent comprising
(a11) on average per molecule at least two functional groups which contain at least one bond activatable with actinic radiation
(a2) at least one thermally curable constituent comprising at least two isocyanate-reactive groups, and
(a3) at least one aromatic polyisocyanate which is free from functional groups (a11).

2. The coating material of claim 1, wherein constituent (a1) further comprises at least one isocyanate-reactive group (a12).

3. The coating material of claim 1, wherein the functional groups (a11) comprise carbon-carbon double bonds.

4. The coating material of claim 3, wherein the functional groups (a11) comprise acrylate groups.

5. The coating material claim 2 4, wherein the functional groups (a12) are selected from the group consisting of hydroxyl groups, thiol groups, primary amino groups, secondary amino groups, and imino groups.

6. The coating material of claim 1, wherein constituent (a2) comprises an oligomer or polymer selected from the group consisting of (meth)acrylate (co)polymers, polyesters, alkyds, amino resins, polyurethanes, polylactones, polycarbonates, polyethers, epoxy resin-amine adducts, (meth)acrylatediols, partially saponified polyvinyl esters, and polyureas.

7. The coating material of claim 1, wherein constituent (a3) further comprises a (cyclo)aliphatic polyisocyanate free of functional groups (a11) and the weight ratio of aromatic polyisocyanate to (cyclo)aliphatic polyisocyanate is from 95:5 to 5:95.

8. The coating material of claim 1, wherein the aromatic polyisocyanate (a3) is selected from the group consisting of polyisocyanates based on the technical-grade mixtures of 2,4- and 2,6-tolylene diisocyanate.

9. The coating material of claim 7, wherein the (cyclo)alphatic polyisocyanate is selected from the group consisting of polyisocyanates based on hexamethylene diisocyanate and polyisocyanates based on isophorone diisocyanate.

10. The coating material of claim 1, wherein the coating material further comprises at least one electrically conductive pigment.

11. (canceled)

12. The coating material of claim 10, wherein the electrically conductive pigment is a mica pigment.

13. The coating material of claim 1, further comprising a transparent filler.

14. The coating material of claim 13, wherein the filler is transparent to UV radiation.

15. A process for coating a microporous surface, comprising applying the coating material of claim 1 to a microporous surface to provide a coated surface, and curing the coated surface thermally and with actinic radiation.

16. The process of claim 15, further comprising drying the coated surface to provide an incompletely cured coating, exposing the incompletely cured coating to actinic radiation to provide a radiation cured coating, and overcoating the radiation cured coating.

17. The process of claim 16, further comprising thermally curing the radiation cured coating before overcoating.

18. (canceled)

19. The process of claim 15, further comprising
(1) applying the coating material of claim 1 to a microporous surface to provide a film, wherein the coating material is electrically nonconductive,
(2) partially curing the film with actinic radiation to provide a part-cured film,
(3) overcoating the part-cured film with the electrically conductive coating material of claim 10 to provide an overcoated film, and
(4) curing the overcoated film thermally.

20. The process of claim 15, wherein the micorporous surface comprises pores having a size of from 10 to 1500 nm.

21. The process of claim 15, wherein the microporous surface is electrically conductive.

22. The process of claim 15, wherein the microporous surface comprises a component for motor vehicle construction.

23. The process of claim 22, wherein the component is at least one of Sheet Molded Compound or Bulk Molded Compound.

24. The process of claim 15, wherein thermal curing takes place at temperatures of up to 120° C.
